(19) United States
(12) Patent Application Publication
(10) Pub. No.: US 2017/0301269 A1
(43) Pub. Date: Oct. 19, 2017

(54) VENDOR BOARD SYSTEM

(71) Applicant: LaTanya Grigsby, Minden, LA (US)

(72) Inventor: LaTanya Grigsby, Minden, LA (US)

(21) Appl. No.: 15/478,190

(22) Filed: Apr. 3, 2017

Related U.S. Application Data
(60) Provisional application No. 62/324,761, filed on Apr. 19, 2016.

(51) Int. Cl. G09F 15/00; G09F 1/04

(52) U.S. Cl. CPC G09F 15/0062; G09F 1/04

(57) ABSTRACT

A vendor board system having a vendor board assembly having a light-weight tri-fold board having a front surface and a back surface, the front surface including a plurality of image displays and text displays for displaying marketing information and conveying messages.

### CROSS REFERENCE TO RELATED APPLICATION

The present application is related to and claims priority to U.S. Provisional Patent Application No. 62/324,761 filed Apr. 19, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of marketing materials and more specifically relates to a vendor board system.

### 2. Description of Related Art

Many individuals like to display products or services for the public to view. It can be difficult for sales representatives at parties or conferences to talk to each potential customer who visits their booth or table. In fact, some representatives may lose out on sales if they are talking to one customer and another customer has questions about various products. A suitable solution is desired.

U.S. Pat. No. 7,040,899 to Ronald G. Armstrong relates to a portable presentation display. The described portable presentation display includes an ultra-light presentation display case is a slim, lightweight portable case that can be easily carried to the site of a presentation. The case easily folds open to provide a multi surfaced, free standing exhibit display. The display case comprises three lightweight, rigid structural panels, each panel encapsulated by a rigid frame, the three panels hinged together, allowing the two outer panels to be folded towards the center panel, and a handle fixedly secured to the top of the center structural panel. Each of the panels is made from a rigid, lightweight polystyrene foam core. The front surface of the panels is covered with a Velcro® compatible loop material. The rear surface of the panels is covered with a thermoplastic polymer that is heated and formed to create a corrugated pattern providing both structural integrity and an embossed area wherein a logo or other advertising can be affixed.

### BRIEF SUMMARY OF THE INVENTION

In view of the foregoing disadvantages inherent in the known marketing materials art, the present disclosure provides a novel vendor board system. The general purpose of the present disclosure, which will be described subsequently in greater detail, is to provide a trifold vendor display board.

A vendor board system is disclosed herein. The vendor board system includes a vendor board assembly having a light-weight tri-fold board having a front surface and a back surface, and a handle. The front surface may comprise a plurality of image displays and text displays for displaying marketing information and conveying functional messages in an organized and logical displayment conducive to promotion of the image displays presented thereon.

In certain embodiments, the trifold board may include a handle. The handle may comprise plastic or other suitable materials. Functional messages are able to direct website traffic via a website address and alternately via a QR code such that a vendor does not have to manually attend the board system to provide product-information. Other visual means for connecting to an internet website may be used. The handle may be adhered to the tri-fold board via a fastener which may include hook-and-loop fasteners. The handle is adhered on the back side of the tri-fold board in preferred embodiments. The tri-fold board comprises corrugated plastic. The tri-fold board comprises a height of approximately 36 inches. The tri-fold board comprises a length of approximately 24 inches. The tri-fold board comprises a thickness of approximately 1 inch.

The vendor board assembly displays product photos and product descriptions in a functional and logical manner for marketing or promotion purposes. The tri-fold board comprises three panels each connected via a hinged portion. Products may be displayed in front of the tri-fold board to further market the products. The text displays may include ingredient lists, descriptions of a purpose of the product, or other relevant information regarding the product.

A method of monetizing vendor items is also disclosed herein including the steps of setting up a vendor board assembly having a light-weight tri-fold board having a front surface and a back surface, the front surface comprising a plurality of image displays and text displays for displaying marketing information and conveying functional messages in an organized and logical displayment conducive to promotion of the image displays presented thereon; and inducing potential clients to purchase the vendor items via functional information displayed on the vendor board from at least one website.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a vendor board system, constructed and operative according to the teachings of the present disclosure.

FIG. 1 is a front perspective view of the vendor board system during an ‘in-use’ condition, according to an embodiment of the disclosure.

FIG. 2 is a front perspective view of the vendor board system of FIG. 1, according to an embodiment of the present disclosure.

FIG. 3 is a front perspective view of the vendor board system of FIG. 1, according to an embodiment of the present disclosure.

FIG. 4 is a front perspective view of the vendor board system of FIG. 1, according to an embodiment of the present disclosure.

FIG. 5 is a flow diagram illustrating a method of use for the vendor board system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to marketing materials and more particularly to a vendor board system as used to improve the marketing and displaying of products.

Generally, the present invention provides an attractive and detailed way to display products for sale and as designed it accommodates a wide range of products with ample space. The device features both text and visual representations of products to enhance product knowledge. Further, it includes a handle for easy carrying to sales parties, business conferences, and the like. The present invention sets on a table or easel to attract further attention. Vendor board system displays a vast array of products using pictures and product descriptions. This innovative product may comprise a lightweight, durable tri-fold board, made from durable corrugated plastic or other suitable material. The present invention acts as a backdrop for displaying the products out front of the board.

A plastic handle may adhere to the back of the board via hook-and-loop fasteners, making it easy to transport. Other fastening means may be used. The tri-fold nature of the board allows sales representatives to stand up the board on a table or easel for prominent display. Further, the vendor board system can double as an ideal way to display images and text at family reunions, school functions, parties, business meetings, and more. The vendor board system can measure approximately 36″ in height, 24″ in length and 1″ thick when opened and about 24″ in height, 24″ in length, and 1″ thick when closed. Additionally, the vendor board system can be offered in assorted colors to accommodate user preferences and needs. The exact specifications may vary upon manufacturing.

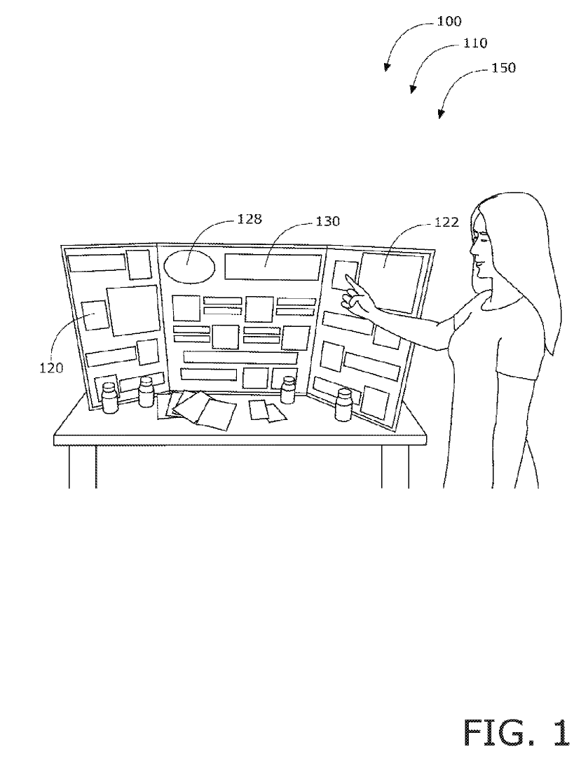

Referring now more specifically to the drawings by numerals of reference, there is shown in FIGS. 1-5, various views of a vendor board system 100. FIG. 1 shows a vendor board system 100 during an ‘in-use’ condition 150, according to an embodiment of the present disclosure. As illustrated, the vendor board system 100 may include a vendor board assembly 110 having a light-weight tri-fold board 120 having a front surface 122 and a back surface 124. The front surface 122 comprises a plurality of image displays 128 and text displays 130 for displaying marketing information and conveying functional messages in an organized and logical displayment conducive to promotion of said image displays 128 presented thereon.

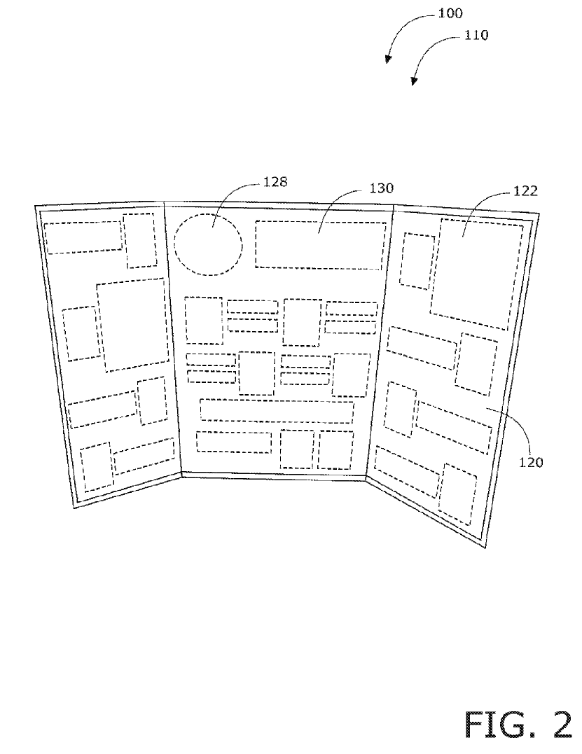

FIG. 2 shows a front perspective view of the vendor board system 100 of FIG. 1, according to an embodiment of the present disclosure. As above, the vendor board system 100 may include a tri-fold board 120 comprising corrugated plastic or other suitable material. The tri-fold board 120 comprises a height of approximately 36 inches. The tri-fold board 120 comprises a length of approximately 24 inches. The tri-fold board 120 comprises a thickness of approximately 1 inch.

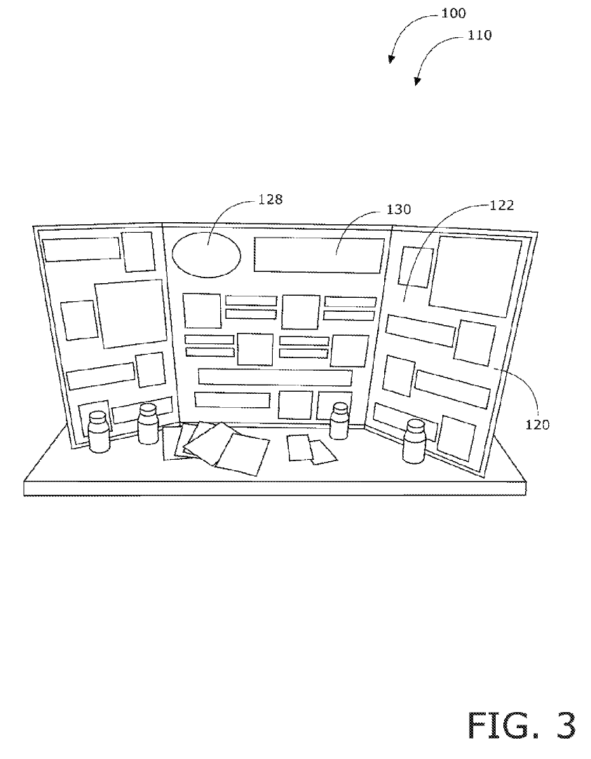

FIG. 3 shows a front perspective view of the vendor board system 100 of FIG. 1, according to an embodiment of the present disclosure. As above, the vendor board system 100 may include a tri-fold board 120. The vendor board assembly 110 displays product photos and product descriptions. The tri-fold board 120 comprises three panels each connected via a hinged portion. The hinged portion allows for folding and storing the tri-fold board. Products are displayed in front of the tri-fold board 120 to further market the products. The text displays 130 include ingredient lists. The text displays 130 include a description of a purpose of the product.

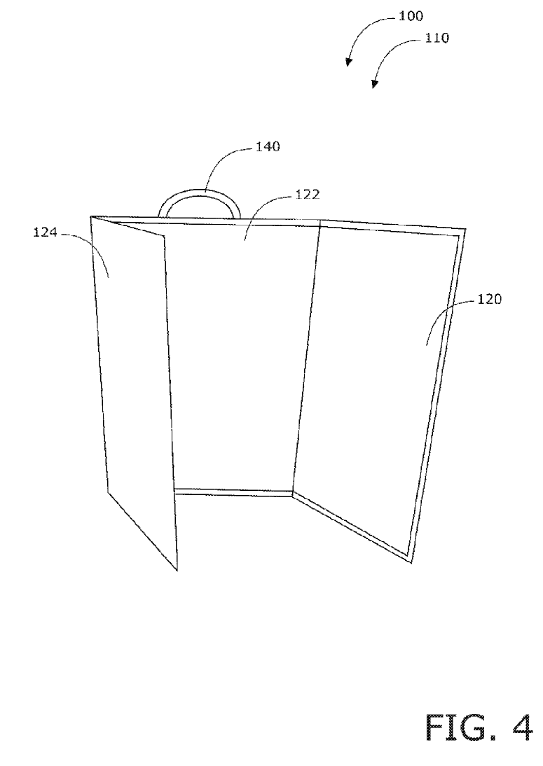

Referring now to FIG. 4 showing a front perspective view of the vendor board system 100 of FIG. 1, according to an embodiment of the present disclosure. As above, the vendor board system 100 may include a tri-fold board 120 having a handle 140. The handle 140 preferably comprises plastic and functional messages are able to direct website traffic via a website address and alternately via a QR code such that a vendor does not have to manually attend the table or display. The board system 100 is able to provide product-information. The handle 140 is adhered to said tri-fold board 120 via a fastener. The handle 140 allows users to carry the device to sales parties, business conferences, and the like. The fastener comprises hook-and-loop fasteners or other fasteners may be used. The handle 140 is adhered on the back side of the tri-fold board 120.

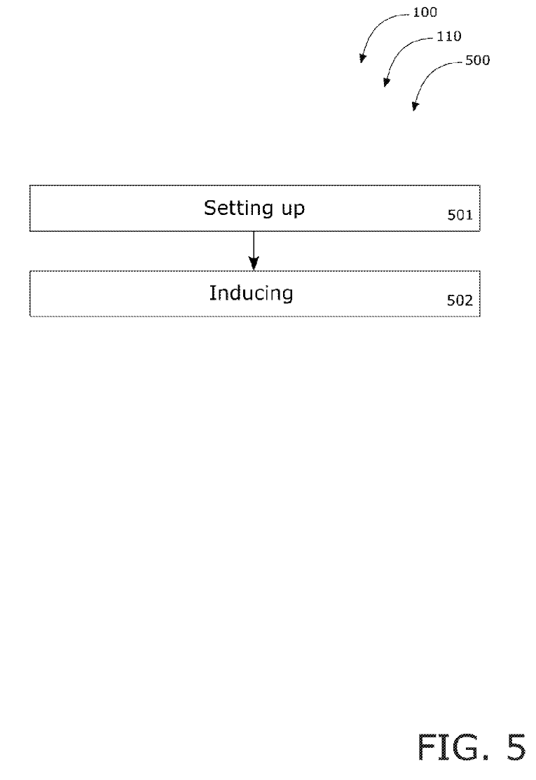

FIG. 5 shows a method of use 500 for the vendor board system 100 of FIG. 1, according to an embodiment of the present disclosure. A method 500 of monetizing vendor items is also disclosed herein including the steps of: step one 501, setting up a vendor board assembly 110 having a light-weight tri-fold board 120 having a front surface 122 and a back surface 124. The front surface 122 comprises a plurality of image displays 128 and text displays 130 for displaying marketing information and conveying functional messages in an organized and logical displayment conducive to promotion of said image displays 128 presented thereon; and step two 502, inducing potential clients to purchase vendor items via information displayed on the vendor board from at least one website. In this way the device can be unmanned and still avail sales for consumers.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A vendor board system and method comprising:
a vendor board assembly having;
a light-weight tri-fold board having a front surface and a back surface, the front surface comprising a plurality of image displays and text displays for displaying marketing information and conveying functional messages in an organized and logical displayment conducive to promotion of said image displays presented thereon.

2. The vendor board system of claim 1, wherein the tri-fold board comprises a handle.

3. The vendor board system of claim 1, wherein the handle comprises plastic and said functional messages able to direct website traffic via a website address and alternately via a code such that a vendor does not have to manually attend said board system to provide product-information.

4. The vendor board system of claim 1, wherein the handle is adhered to said tri-fold board via a fastener.

5. The vendor board system of claim 1, wherein the fastener comprises hook-and-loop fasteners.

6. The vendor board system of claim 1, wherein the handle is adhered on the back side of the tri-fold board.

7. The vendor board system of claim 1, wherein the tri-fold board comprises corrugated plastic.

8. The vendor board system of claim 1, wherein the tri-fold board comprises a height of approximately 36 inches.

9. The vendor board system of claim 8, wherein the tri-fold board comprises a length of approximately 24 inches.

10. The vendor board system of claim 9, wherein the tri-fold board comprises a thickness of approximately 1 inch.

11. The vendor board system of claim 1, wherein the vendor board assembly displays product photos and product descriptions.

12. The vendor board system of claim 1, wherein the tri-fold board comprises three panels each connected via a hinged portion.

13. The vendor board system of claim 1, wherein the hinged portion allows for folding and storing the tri-fold board.

14. The vendor board system of claim 11, wherein products are displayed in front of the tri-fold board to further market the products.

15. The vendor board system of claim 1, wherein the text displays include ingredient lists.

16. The vendor board system of claim 15, wherein the text displays include a description of a purpose of the product.

17. The vendor board system of claim 1 comprising
a vendor board assembly having;
a light-weight tri-fold board having a front surface and a back surface, and a handle, the front surface comprising a plurality of image displays and text displays for displaying marketing information and conveying functional messages in an organized and logical displayment conducive to promotion of said image displays presented thereon;
wherein the handle comprises plastic and said functional messages able to direct website traffic via a website address and alternately via a QR code such that a vendor does not have to manually attend said board system to provide product-information;
wherein the handle is adhered to said tri-fold board via a fastener;
wherein the fastener comprises hook-and-loop fasteners;
wherein the handle is adhered on the back side of the tri-fold board;
wherein the tri-fold board comprises corrugated plastic;
wherein the tri-fold board comprises a height of approximately 36 inches;
wherein the tri-fold board comprises a length of approximately 24 inches;
wherein the tri-fold board comprises a thickness of approximately 1 inch;
wherein the vendor board assembly displays product photos and product descriptions;
wherein the tri-fold board comprises three panels each connected via a hinged portion;
wherein products are displayed in front of the tri-fold board to further market the products;
wherein the text displays include ingredient lists; and
wherein the text displays include a description of a purpose of the product.

18. The vendor board system of claim 17, further comprising set of instructions; and
wherein the vendor board system is arranged as a kit.

19. A vendor board system, the method of monetizing vendor items comprising the steps of:
setting up a vendor board assembly having a light-weight tri-fold board having a front surface and a back surface, the front surface comprising a plurality of image displays and text displays for displaying marketing information and conveying functional messages in an organized and logical displayment conducive to promotion of said image displays presented thereon; and
inducing potential clients to purchase said vendor items via functional information displayed on said vendor board from at least one website.

20. The method of claim 19, wherein said light-weight tri-fold board is able to be unmanned
